(19) United States
(12) Patent Application Publication
(10) Pub. No.: US 2025/0267221 A1
(43) Pub. Date: Aug. 21, 2025

(54) NON-TRANSITORY COMPUTER-READABLE STORAGE MEDIUM STORING PRINTING CONTROL PROGRAM, FAX CONTROL DEVICE, AND FAX CONTROL METHOD

(71) Applicant: SEIKO EPSON CORPORATION, Tokyo (JP)

(72) Inventor: Masatsugu INOUE, Shiojiri (JP)

(21) Appl. No.: 19/052,333

(22) Filed: Feb. 13, 2025

(30) Foreign Application Priority Data
Feb. 15, 2024 (JP) 2024-020970

(51) Int. Cl. H04N 1/00

(52) U.S. Cl. CPC H04N 1/00238; H04N 2201/0093

(57) ABSTRACT

There is provided a non-transitory computer-readable storage medium storing a printing control program, the printing control program causing a computer to execute display processing, acquisition processing, and instruction processing. In the display processing, a setting image is displayed in response to a request from a general-purpose printer driver. In the acquisition processing, a FAX transmission destination to be a destination of FAX is acquired via the setting image. In the instruction processing, print control data including the FAX transmission destination is passed to the general-purpose printer driver and the general-purpose printer driver is caused to execute a print instruction conforming to the print control data and serving as a FAX transmission instruction to a printer having a FAX transmission function.

The present application is based on, and claims priority from JP Application Serial Number 2024-020970, filed Feb. 15, 2024, the disclosure of which is hereby incorporated by reference herein in its entirety.

### BACKGROUND

### 1. Technical Field

The present disclosure relates to a non-transitory computer-readable storage medium storing a printing control program, a FAX control device, and a FAX control method.

### 2. Related Art

JP-A-2021-56754 discloses a technique for causing a printer to perform booklet printing in an information processing device in which an operating system (OS) standard printer driver, which is an OS standard printing program, is incorporated.

JP-A-2021-56754 is an example of the related art.

However, a general-purpose printer driver such as an OS standard printer driver used in the technique described in JP-A-2021-56754 does not support FAX transmission. Thus, it is desired to develop a technique for enabling FAX transmission in an environment in which printing processing using a general-purpose printer driver is performed.

### SUMMARY

According to an aspect of the present disclosure, there is provided a non-transitory computer readable storage medium storing a printing control program, the printing control program causing a computer to execute: display processing of displaying a setting image in response to a request from a general-purpose printer driver; acquisition processing of acquiring, via the setting image, a FAX transmission destination to be a destination of FAX; and instruction processing of passing print control data including the FAX transmission destination to the general-purpose printer driver and causing the general-purpose printer driver to execute a print instruction conforming to the print control data and serving as a FAX transmission instruction to a printer having a FAX transmission function.

According to an aspect of the present disclosure, there is provided a FAX control device including: a general-purpose printer driver; a display processing unit configured to display a setting image in response to a request from the general-purpose printer driver; an acquisition processing unit configured to acquire, via the setting image, a FAX transmission destination to be a destination of a FAX; and an instruction processing unit configured to pass print control data including the FAX transmission destination to the general-purpose printer drive and cause the general-purpose printer driver to execute a print instruction conforming to the print control data and serving as a FAX transmission instruction to a printer having a FAX transmission function.

According to an aspect of the present disclosure, there is provided a FAX control method including: display processing of displaying a setting image in response to a request from a general-purpose printer driver; acquisition processing of acquiring, via the setting image, a FAX transmission destination to be a destination of FAX; and instruction processing of passing print control data including the FAX transmission destination to the general-purpose printer driver and causing the general-purpose printer driver to execute a print instruction conforming to the print control data and serving as a FAX transmission instruction to a printer having a FAX transmission function.

### BRIEF DESCRIPTION OF THE DRAWINGS

FIG. 1 is a block diagram illustrating a configuration example of a print system according to an embodiment.

FIG. 2 is a sequence diagram illustrating a first example of FAX transmission processing in the print system illustrated in FIG. 1.

FIG. 3 is a sequence diagram following FIG. 2.

FIG. 4 is a diagram illustrating an example of a user interface image displayed in the FAX transmission processing illustrated in FIGS. 2 and 3.

FIG. 5 is a diagram illustrating another example of the user interface image displayed in the FAX transmission processing illustrated in FIGS. 2 and 3.

FIG. 6 is a diagram illustrating another example of the user interface image displayed in the FAX transmission processing illustrated in FIGS. 2 and 3.

FIG. 7 is a diagram illustrating another example of the user interface image displayed in the FAX transmission processing illustrated in FIGS. 2 and 3.

FIG. 8 is a diagram illustrating another example of the user interface image displayed in the FAX transmission processing illustrated in FIGS. 2 and 3.

FIG. 9 is a sequence diagram illustrating a second example of the FAX transmission processing in the print system illustrated in FIG. 1.

FIG. 10 is a sequence diagram following FIG. 9.

FIG. 11 is a diagram illustrating an example of hardware components of a device.

### DESCRIPTION OF EMBODIMENTS

An embodiment of the present disclosure is explained below with reference to the drawings. Figures are merely exemplification for explaining the embodiment of the present disclosure. Not all of elements explained in the embodiment of the present disclosure are essential elements of the present disclosure.

### EMBODIMENT

### Configuration of a System

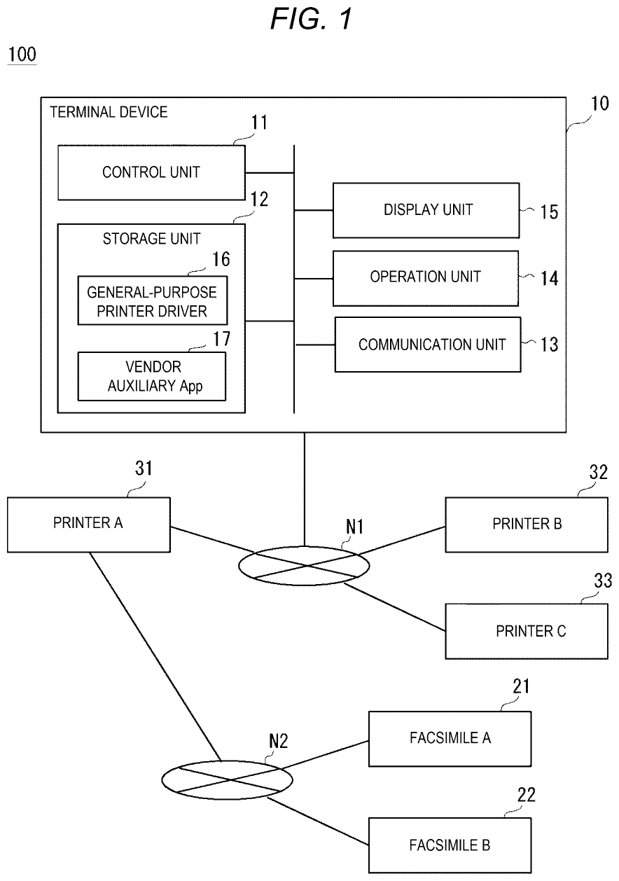

An exemplary configuration of a print system according to the present embodiment is explained with reference to FIG. 1. FIG. 1 is a block diagram illustrating the configuration example of the print system according to the embodiment.

As illustrated in FIG. 1, a print system 100 according to the present embodiment can include a terminal device 10, a facsimile A(21), a facsimile B(22), a printer A(31), a printer B(32), and a printer C(33).

The terminal device 10 is an information processing device including a communication function such as a personal computer (PC), a smartphone, or a tablet terminal and can be used by a user who desires FAX transmission and printing. The terminal device 10 is connected to the printer A(31), the printer B(32), and the printer C(33) via a network N1 for, for example, processing of transmitting a print request. The print request can include a FAX transmission request transmitted to the facsimile A(21), the facsimile B(22), or the like.

Although not illustrated, the print system 100 can include a plurality of terminal devices 10. Since the print system 100 is configured to be capable of performing FAX transmission from a printer, the print system 100 can also be referred to as a FAX system or a FAX transmission system.

All of the printer A(31), the printer B(32), and the printer C(33) are examples of a printer having a FAX transmission function. When receiving print data, the printer A(31), the printer B(32), and the printer C(33) can print the print data on a medium. When receiving print data designating a FAX transmission destination, the printer A(31), the printer B(32), and the printer C(33) can transmit FAX to the FAX transmission destination. The printers can also be configured to be capable of receiving FAX as well. The printers produce prints by performing printing and perform m FAX transmission to produce transmission data serving as a transmission object.

For convenience, the print system 100 is explained on the premise that three printers are provided in the print system 100 as explained above. However, at least one printer only has to be provided in the print system 100. The printers only have to be devices having a facsimile transmission function, a communication function, and a print function but may be a multifunction peripheral having other functions such as a scanner function and a copy function. The printers can also be referred to as a printing apparatus or an image forming apparatus. A printing scheme in the printers do not matter. Various printing schemes such as an inkjet printing scheme and a laser printing scheme can be applied.

The facsimile A(21) and the facsimile B(22) are examples of a facsimile machine that receives FAX. As an example of a FAX transmission destination from the printer A(31), the facsimile A(21) and the facsimile B(22) connected to the printer A(31) via a network N2 are illustrated. However, the FAX transmission destination is not limited to these facsimiles. For example, when the printer B(32) or the printer C(33) is connected to the network N2, the printer B(32) or the printer C(33) can perform FAX transmission with the facsimile A(21) and the facsimile B(22) set as FAX transmission destinations. The FAX transmission destination is not limited to at least one of the facsimile A(21) and the facsimile B(22) and may be another not-illustrated facsimile device and the number of facsimile devices may be three or more. The facsimile devices such as the facsimile A(21) and the facsimile B(22) can be configured to be capable of transmitting FAX as well. The network N2 is usually a public telephone network.

The print system 100 performs, according to user operation from the terminal device 10, FAX transmission from a selected printer among the printer A(31), the printer B(32), and the printer C(33) to a FAX transmission destination selected by the user operation. The print system 100 performs, according to user operation from the terminal device 10, printing from a selected printer among the printer A(31), the printer B(32), and the printer C(33). A configuration example of the terminal device 10 is explained in detail below. Explanation of configuration examples of the printers and configuration examples of the facsimile machines is omitted.

### Configuration of the Terminal Device 10

As illustrated in FIG. 1, the terminal device 10 can include a control unit 11, a storage unit 12, a communication unit 13, an operation unit 14, and a display unit 15.

The control unit 11 controls the entire terminal device 10. The control unit 11 can include, for example, an arithmetic processing device, a working memory, and a storage device that stores a control program, parameters, and the like. The arithmetic processing device can be a central processing unit (CPU), a graphics processing unit (GPU), or the like. The control unit 11 can also be implemented as a system on a chip (SoC). As it is seen from the examples explained above, the control unit 11 can be configured to store the control program in an executable state. However, the control unit 11 can also be configured to store a part of the control program as a circuit configuration like a field programmable gate array (FPGA) or can be configured as a dedicated circuit.

The control program can include a program for the arithmetic processing device to execute processing relating to printing in cooperation with the storage unit 12, the communication unit 13, the operation unit 14, and the display unit 15. The control program can include an OS. Since the OS is an OS equipped in the terminal device 10, the OS is an OS of a type corresponding to a model and the like of the terminal device 10. The control program can include a Web browser in the OS or outside the OS. In the following explanation, an example in which at least a part of the control program is stored in the storage unit 12 provided separately from the control unit 11 is explained. However, the storage unit 12 may be a part of a storage device in the control unit 11. That is, the storage unit 12 can be grasped as a part of the control unit 11.

The storage unit 12 is, for example, a storage device by a hard disk drive, a solid state drive, or another memory. The storage unit 12 stores, as part of the control program, a general-purpose printer driver 16 and a vendor auxiliary Application program 17 explained below in a state executable from the control unit 11. In the following explanation, the vendor auxiliary Application program is abbreviated as vendor auxiliary App. The storage unit 12 can store various data such as a file to be printed or a FAX transmission target.

The communication unit 13 is a part that conforms to a predetermined communication standard such as various mobile communication standards and a Wi-Fi (registered trademark, the same applies below) standard and communicates with external devices such as the printer A(31), the printer B(32), and the printer C(33) via the network N1, via a wireless or wired connection. The communication unit 13 can be configured by one or a plurality of communication interfaces capable of performing such communication. The network N1 is usually a Local area network (LAN).

The operation unit 14 is a part that receives operation by the user of the terminal device 10 and can be referred to as operation reception unit as well. The operation unit 14 can be implemented by, for example, any one or a plurality among a physical button, a touch panel mounted on the display unit 15, a pointing device, and a keyboard. In a configuration in which the operation unit 14 includes the touch panel, the operation unit 14 including the display unit 15 and the touch panel can be collectively referred to as operation panel of the terminal device 10.

The display unit 15 is a part for displaying a user interface (UI) image for operating the terminal device 10 and is configured by a display device such as a liquid crystal display or an organic electroluminescence display. The display unit 15 can also include a display and a drive circuit that drives the display.

The general-purpose printer driver 16 is explained. The general-purpose printer driver 16 is an OS-standard printer driver included in an OS included in the control program or attached to the OS. The general-purpose printer driver 16 can be a program capable of controlling various types of printers to execute printing. The general-purpose printer driver 16 can also be referred to as OS general-purpose printing program or general-purpose printing program.

The general-purpose printer driver 16 is a driver that uses a general-purpose protocol for a search for a printer and for printing. For example, the general-purpose printer driver 16 uses mDNS/DNS-SD for the search for a printer and uses IPP for the printing in the printer. Here, DNS is an abbreviation of Domain Name System. mDNS is an abbreviation of multicast DNS. DNS-SD is an abbreviation of DNS Service Discovery. IPP is an abbreviation of Internet Printing Protocol.

As it is seen from this example as well, the general-purpose printer driver 16 can be, for example, an IPP Class driver. IPP is an example of a standard protocol for controlling management of a printer and printing. The IPP acquires and controls printer information according to HTTP (Hyper Text Transfer Protocol) POST requests and responses. In the IPP, it is possible to perform printer setting and printer state acquisition. Here, secure communication can be performed by using HTTP Secure (HTTPS) instead of the HTTP.

The vendor auxiliary App 17 is explained. The vendor auxiliary App 17 is an application program assisting the general-purpose printer driver 16, and is used to expand the functions of the general-purpose printer driver 16. Therefore, the general-purpose printer driver 16 may have a function of starting the vendor auxiliary App 17 and transmitting a print job to the vendor auxiliary App 17. The vendor auxiliary App 17 may be, for example, Print Support Application (PSA).

The vendor auxiliary App 17 may be a program for assisting the general-purpose printer driver 16 and causing a computer to execute printing control suitable for the performance of a target printer, that is, printing control for supporting a unique function of the printer. In the present embodiment, a FAX transmission function is included as a function unique to the printer. Here, the computer indicates the terminal device 10 or the control unit 11. When acquiring a print job from the general-purpose printer driver 16, the vendor auxiliary App 17 can convert the print job such that printing and FAX transmission using unique functions for a designated printer can be executed by the printer.

The vendor auxiliary App 17 is an application program provided by, for example, a vendor of a printer. The vendor auxiliary App 17 can be provided to the user of the terminal device 10 by being disclosed in, for example, an application store of an OS provider. Alternatively, the vendor auxiliary App 17 can be provided to the user by being included in the OS or attached to the OS.

The vendor auxiliary App 17 includes a printing control program described below. That is, the printing control program can also be implemented as, for example, a PSA. The printing control program is a program for causing a computer to execute display processing, acquisition processing, and instruction processing explained below. Here, the computer also indicates the terminal device 10 or the control unit 11.

The display processing causes the display unit 15 to display a setting image in response to a request from the general-purpose printer driver 16. The setting image can be a UI image for setting. In the following explanation, the setting image is explained as a setting UI image. An example of the setting UI image is explained below in an example of the FAX transmission processing. This request is executed by inter-process communication between the general-purpose printer driver 16 and the printing control program. This request can be executed, for example, when user operation for displaying a detailed setting UI image is received from the operation unit 14 in the general-purpose printer driver 16.

In the acquisition processing, a FAX transmission destination to be a destination of FAX is acquired via the setting UI image. In this acquisition processing, user operation for designating a FAX transmission destination can be acquired by receiving the user operation from the operation unit 14 via the setting UI image.

In the instruction processing, the print control data including the FAX transmission destination is passed to the general-purpose printer driver 16 to cause the general-purpose printer driver 16 to execute a print instruction to the printer according to the print control data. This printer is a printer having a FAX transmission function and, in the example illustrated in FIG. 1, the printer indicates a printer selected by user operation from the terminal device 10 among the printer A(31), the printer B(32), and the printer C(33). Since the print control data is data including the FAX transmission destination, the print instruction explained above is a FAX transmission instruction.

The general-purpose printer driver 16 that has received such a request for the print instruction can perform FAX transmission instruction by giving a print instruction to a target printer. For example, when the target printer is the printer A(31) and the FAX transmission destinations are the facsimile A(21) and the facsimile B(22), for example, processing explained below is performed. That is, the general-purpose printer driver 16 sends the print instruction to the printer A(31) and the printer A(31) having received the print instruction transmits target print data to the facsimile A(21) and the facsimile B(22) by FAX.

The printing control program is a program for causing a computer to execute FAX transmission. Therefore, the printing control program can also be referred to as FAX transmission program. Further, since the printing control program is a program for performing FAX transmission, the printing control program can also be referred to as FAX control program.

In other words, the present embodiment can provide a FAX control method including the display processing, the acquisition processing, and the instruction processing explained above. The FAX control method is a method of executing FAX transmission. Therefore, the FAX control method can also be referred to as FAX transmission method. Since the FAX control method is a method of performing FAX transmission as a part of print control, the FAX control method can also be referred to as print control method.

Further, in other words, the terminal device 10 includes the general-purpose printer driver 16 and a first acquisition processing a unit, second acquisition processing unit, and a notification processing unit explained below. The terminal device 10 can also be referred to as FAX transmission device or printing control device for the same reason as the reason for rephrasing the FAX control method.

A display processing unit displays a setting UI image in response to a request from the general-purpose printer driver 16. An acquisition processing unit acquires a FAX transmission destination to be a destination of FAX via the setting UI image. The acquisition processing unit can also be referred to as a destination acquisition unit for acquiring the destination of the FAX. An instruction processing unit passes print control data including the FAX transmission destination to the general-purpose printer driver 16 and causes the general-purpose printer driver 16 to execute a print instruction conforming to the print control data and serving as a FAX transmission instruction to a printer having a FAX transmission function. The instruction processing unit requests the general-purpose printer driver 16 to execute the print instruction. Therefore, the instruction processing unit can also be referred to as an instruction requesting unit or a print instruction requesting unit.

### Effects of the Present Embodiment

Before a more specific example of the FAX transmission processing in the present embodiment is explained, effects of the present embodiment are explained.

As explained above, in the print system 100, the printing control program causes the general-purpose printer driver 16 to perform the FAX transmission instruction as the print instruction. Thus, according to the present embodiment, it can be said that, in the printing processing using the general-purpose printer driver 16, it is possible to execute the FAX transmission processing that cannot be handled only by the general-purpose printer driver 16. That is, according to the present embodiment, it is possible to perform FAX transmission in an environment in which printing processing using a general-purpose printer driver is performed, that is, perform FAX transmission using a general-purpose printer driver.

In order to supplement such effects, the present embodiment, and a print system according to a comparative example are compared. In the print system according to the comparative example, a printer is controlled using a general-purpose printer driver incorporated in the Windows (registered trademark, the same applies below) OS as a standard without using a printer driver of a vendor. In the general-purpose printer driver in this comparative example as well, a general-purpose protocol is used for a search for a printer and printing. Further, in the general-purpose printer driver in the comparative example as well, a mechanism for starting a vendor auxiliary Application program linked with a printer and customizing a custom print setting and IPP communication at the time of printing is provided. Naturally, the vendor auxiliary Application and the general-purpose printer driver according to the comparative example do not include the printing control program explained above.

However, the general-purpose printer driver itself does not support FAX transmission. The custom print setting in the comparative example is limited to general setting relating to printing. In print setting items that can be set, there are no items such as designation of a destination of FAX and designation of a telephone directory for the designation of the destination of the FAX. Thus, the mechanism according to the comparative example cannot perform FAX transmission from the terminal device.

As explained above, in the comparative example, FAX transmission cannot be performed in the printing processing using the general-purpose printer driver. On the other hand, as explained above, according to the present embodiment, the printing control program for causing the general-purpose printer driver 16 to perform FAX transmission instruction designating a destination as print instruction is introduced. Thus, according to the present embodiment, it can be said that, also in the printing processing using the general-purpose printer driver 16, the FAX transmission processing that cannot be executed in the comparative example can be executed.

### First Example of the FAX Transmission Processing

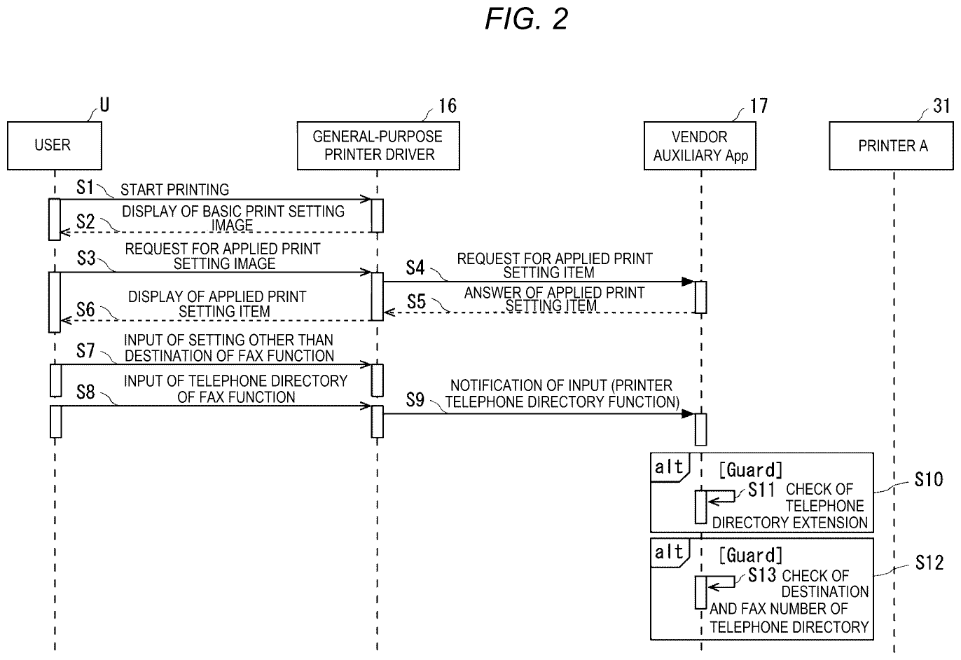

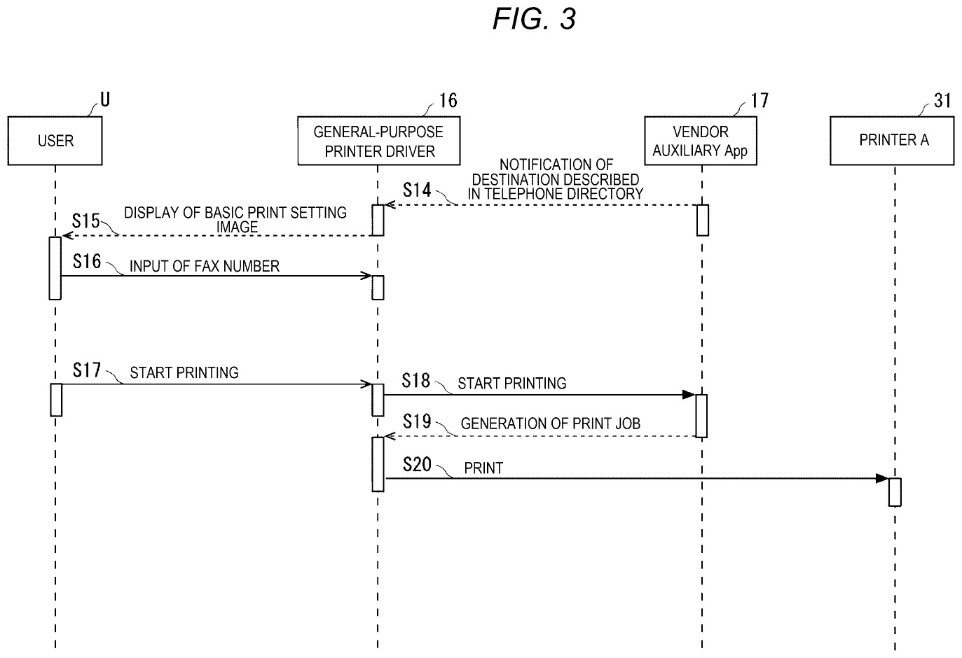

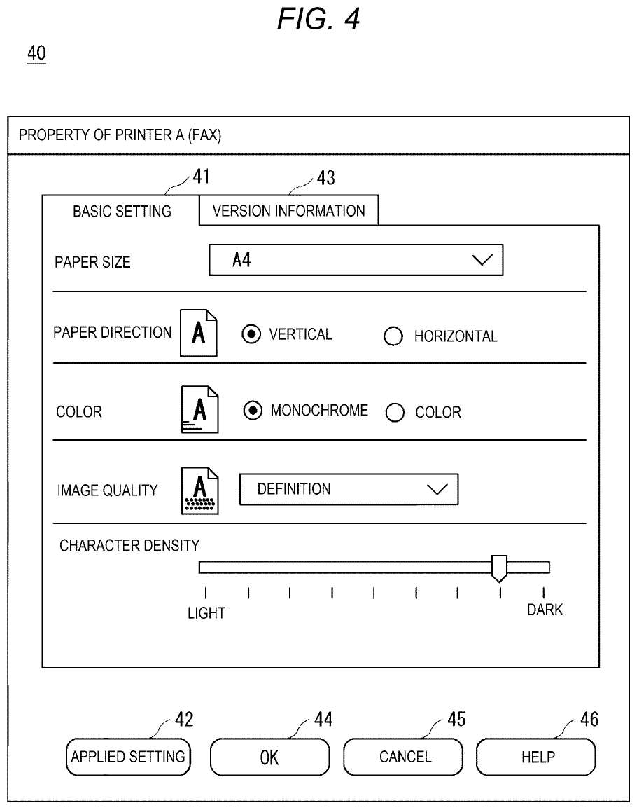

A first example of the FAX transmission processing according to the present embodiment is explained with reference to FIGS. 2 to 8. FIG. 2 is a sequence diagram illustrating example of the FAX transmission processing in the print system 100 illustrated in FIG. 1. FIG. 3 is a sequence diagram following FIG. 2. FIGS. 4 to 8 are diagrams illustrating examples of UI images displayed in the FAX transmission processing illustrated in FIGS. 2 and 3.

In the following explanation as well an example is explained in which the vendor auxiliary App 17 is implemented with the printing control program for performing the display processing, the acquisition processing, and the instruction processing explained above. In the following explanation, an example in the case in which a FAX transmission request is made from the terminal device 10 to the printer A(31) is explained. The same applies when a FAX transmission request is made to the other printers such as the printer B(32) and the printer C(33). In the first example, FAX transmission processing in the case in which a telephone directory function is used to designate a FAX transmission destination is explained. The telephone directory can also be referred to as address book.

First, a user U starts an application program for, for example, starting and editing a FAX transmission target file such as a document file. Then, the user U performs, from the operation unit 14, for example, operation for selecting the printer A(31) having a FAX function in print setting of the FAX transmission target file and selecting a property. With this operation, the general-purpose printer driver 16 receives an instruction to start printing (step S1).

The general-purpose printer driver 16 having received the instruction to start printing from the user U displays a basic print setting image such as the UI image illustrated in FIG. 4 (step S2).

A UI image 40 includes a basic setting tab 41 for receiving user operation for performing basic setting, which is basic setting of printing and may include an applied setting button 42 for receiving user operation for shifting to an applied print setting image for performing detailed setting for printing and applied setting such as FAX transmission setting. In the basic setting tab 41, it is possible to receive, as the basic setting, setting of a paper size, a paper direction, and a color indicating which of color and monochrome is selected. Besides, in the basic setting tab 41, reception of setting of image quality and character density may be enabled. In a state in which the UI image 40 is displayed, the user U can perform these kinds of basic setting.

The UI image can include a version information tab 43, an OK button 44, a cancel button 45, and a help button 46. The OK button 44 is a button selected when content of the basic setting is stored and the UI image 40 is closed. The cancel button 45 is a button selected when the content of the basic setting is discarded and the UI image 40 is closed. The help button 46 is a button selected when a UI image or a page of a site describing information supporting the user U at the time of setting in the UI image 40 is displayed. The applied setting button 42 can also be not included in the UI image 40. In that case, the OK button 44 only has to be a button selected when the content of the basic setting is stored and the UI image 40 is closed and is shifted to the applied print setting image.

In a state in which the UI image 40 is displayed, the user U selects the applied setting button 42 with the operation unit 14 to request the general-purpose printer driver 16 to display the applied print setting image (step S3). This request can also be received by the user U performing, from the operation unit 14, for example, operation for selecting the print button in a state in which the printer A(31) having the FAX function is selected in the print setting for the FAX transmission target file. Thus, even when the UI image 40 does not include the applied setting button 42, the user U can make this request.

The general-purpose printer driver 16 having received this request requests the vendor auxiliary App 17 to transmit an applied print setting item that can be set as a vendor function (step S4). The vendor auxiliary App 17 transmits a predetermined applied print setting item to the general-purpose printer driver 16 as an answer to the request (step S5). The general-purpose printer driver 16 having received the answer embeds, in a predetermined UI image, an applied print setting item that can be set as the vendor function and displays the application print setting item on the display unit 15 (step S6).

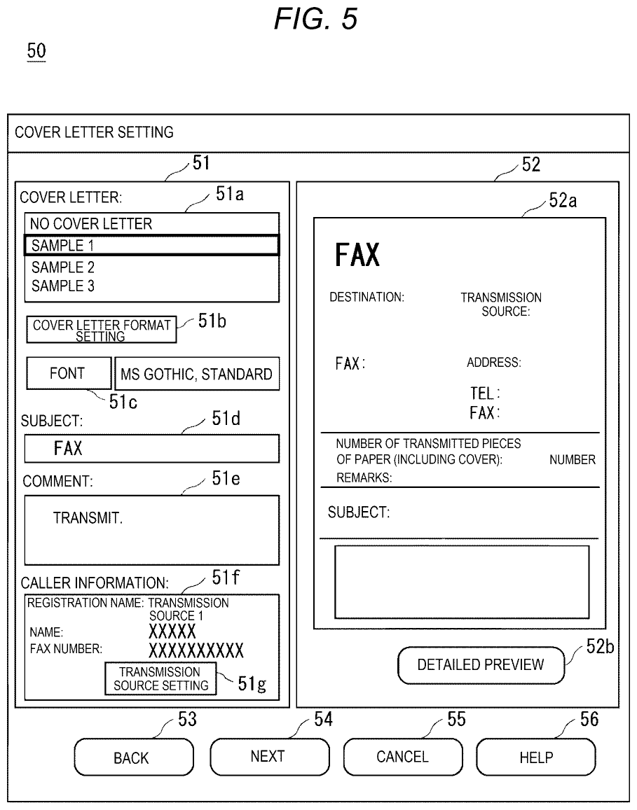

In step S6, for example, a UI image 50 illustrated in FIG. 5 can be displayed as such a UI image. The processing in steps S4 to S6 may be processing explained below. That is, the general-purpose printer driver 16 may request an applied print setting image in step S4, receive the applied print setting image from the vendor auxiliary App 17 in step S5, and display the received applied print setting image as it is or embedded in a predetermined UI image.

The UI image 50 illustrated in FIG. 5 can include a cover letter setting field 51 and a preview field 52. The cover letter setting field 51 can include a selection field 51a for selecting a cover letter desired by the user U out of no cover letter and a plurality of sample cover letters and a cover letter format setting button 51b for shifting to a UI image for setting a cover letter format.

When a next button 54 is selected in a state in which the no cover letter is selected in the selection field 51a in the cover letter setting field 51, the setting is made such that FAX transmission is performed without a cover letter and the UI image shifts to the next UI image. When the next button 54 is selected in a state in which one of the sample cover letters is selected in the selection field 51a, the setting is made such that the FAX transmission based on the selected sample cover letter is performed, and the UI image shifts to the next UI image.

The cover letter setting field 51 can include a setting button 51c for setting a font of characters of a cover letter, a subject field 51d for inputting a subject of the cover letter, a comment field 51e for inputting a comment described in the cover letter, and a caller information field 51f indicating caller information. When the user U selects the setting button 51c, a UI image for selecting a font of characters is displayed and information concerning the selected font is displayed beside the setting button 51c. The caller information field 51f includes a caller setting button 51g for displaying a UI image for setting a caller. Information indicating a caller set by a UI image displayed by selection of the caller setting button 51g is displayed in the caller information field 51f.

The preview field 52 includes a preview display region 52a for displaying a preview image in which contents set in the other setting items in the cover letter setting field 51 are embedded in a sample cover letter selected in the cover letter setting field 51. The preview field 52 can include a detailed preview button 52b for displaying a more detailed preview image.

The UI image 50 can include a return button 53 for returning to the previous UI image, the next button 54 for shifting to the next UI image, a cancel button 55, and a help button 56. The cancel button 55 is a button having the same function as the function of the cancel button 45. Only a target of a UI Image is different. The help button 56 is a button having the same function as the function of the help button 46. Information supporting setting in the UI image 50 is displayed when the help button 56 is selected.

Subsequently, in a state in which the UI image 50 is displayed by the processing of step S6, the user U inputs, from the operation unit 14, setting for a print setting function other than a destination of the FAX function such as setting of a cover letter (step S7). Step S7 may be executed, for example, at any timing after processing in step S8 and before processing in step S17 explained below. For example, it is also possible to adopt shift order of a UI image for performing setting of a cover letter after setting of a FAX transmission destination explained below is performed.

Subsequent to step S7, the user U performs input for designating a telephone directory read from the vendor auxiliary App 17 and the general-purpose printer driver 16 receives this input (step S8). Here, an example is explained in which the user U selects the next button 54 in the UI image 50, whereby a PC-FAX telephone directory automatically stored in the storage unit 12 is designated. The PC-FAX telephone directory is an example of a telephone directory used for FAX transmission from the terminal device 10. That is, in this example, the user U specifies the PC-FAX telephone directory stored in the storage unit 12 automatically by selection operation for the next button 54. Naturally, the user U can select and specify one out of one or a plurality of PC-FAX telephone directories by inputting a path of the PC-FAX telephone directory stored in the storage unit 12. However, a telephone directory to be designated is not limited to this and may be a telephone directory stored by the vendor auxiliary App 17 or the user U may directly input a plurality of FAX numbers and set the plurality of FAX numbers as a telephone directory of a FAX transmission destination. All of these three telephone directory designation methods are methods in which designation is completed by simply referring to data of a telephone directory inside the terminal device 10.

When the input for designating a telephone directory is performed in step S8, the general-purpose printer driver 16 notifies the vendor auxiliary App 17 of the input (step S9).

In response to an instruction in step S9, the vendor auxiliary App 17 reads the input PC-FAX telephone directory and checks whether processing concerning a telephone directory can be performed (step S10). Specifically, the vendor auxiliary App 17 checks whether an extension of the telephone directory is a specific extension (step S11). The specific extension indicates an extension designed to be compatible. When the extension is not the specific extension, it is desirable to notify the user U and urge the user U to input a telephone directory again.

When it is determined that the input PC-FAX telephone directory is the telephone directory having the specific extension, the vendor auxiliary App 17 checks, for the read PC-FAX telephone directory, whether data corresponds to processing in the vendor auxiliary App 17 (step S12). Specifically, the vendor auxiliary App 17 reads the PC-FAX telephone directory and checks whether the input data satisfies a format of a destination and a FAX number (step S13).

In step S13, for example, the check is performed as explained below. First, the vendor auxiliary App 17 checks whether a FAX number is registered for the destination. The destination may be blank. When FAX numbers are not registered for destinations, the vendor auxiliary App 17 desirably notifies the user U and urges the user U to input a telephone directory again.

On the other hand, when a character string of one or more FAX numbers are registered for the destination, the vendor auxiliary App 17 checks whether a character string other than a character string that can be used for the FAX number such as 0 to 9, #, and * is not registered in the FAX number. When a character string other than the character string that can be used for the FAX number is registered, the vendor auxiliary App 17 desirably notifies the user U and urges the user U to input a telephone directory again.

On the other hand, when a character string other than the character string that can be used for the FAX number is not registered, the vendor auxiliary App 17 checks whether the number of characters of the FAX number is within the number of characters of the longest FAX number among the FAX numbers used in the entire world. When the number of characters is not within the number of characters of the longest FAX number, the vendor auxiliary App 17 desirably notifies the user U and urges the user U to input a telephone directory again. On the other hand, when the number of characters is within the number of characters of the longest FAX number, the vendor auxiliary App 17 proceeds to the next processing assuming that all the determinations in step S13 are satisfied.

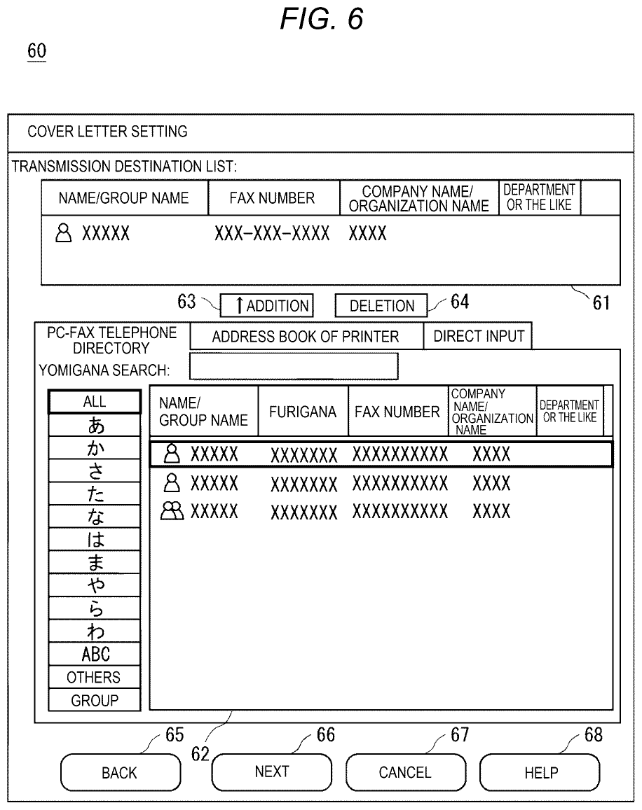

When it is determined in step S13 that the determinations are satisfied, the vendor auxiliary App 17 notifies the destination described in the PC-FAX telephone directory after the check to the general-purpose printer driver 16 (step S14). The general-purpose printer driver 16 having received the notification embeds the PC-FAX telephone directory in a predetermined UI image to display a basic print setting image in which the destination is embedded (step S15). Accordingly, the user U can visually recognize the destination in the PC-FAX telephone directory. An example of a basic print setting image in which such a destination is embedded is a UI image 60 illustrated in FIG. 6. In the following explanation, an example in which the UI image 60 is displayed is explained. In step S15, not only the destination but also another format may be embedded in the predetermined UI image or a UI image in which a format is also predetermined may be used as the predetermined UI image.

The UI image 60 can include a transmission destination list 61, a telephone directory destination list 62, an addition button 63, and a delete button 64. The telephone directory destination list 62 indicates a list of destinations registered in the PC-FAX telephone directory notified in step S14. In the telephone directory destination list 62, all of the registered destinations or a part of destinations extracted based on user operation are arranged and displayed in predetermined order such as the order of 50 notes and alphabetical order. The destinations can include, for example, items such as a name or a group name, a furigana of the name of the group name, a FAX number, a company or organization name, and a department as information. The user selects one or a plurality of destinations out of the telephone directory destination list 62 and selects the add button 63 to thereby be able to copy or move the selected destination (destinations) to a transmission destination list 61 set as FAX transmission destinations. The user selects one or a plurality of destinations out of the transmission destination list 61 and selects the delete button 64 to thereby be able to delete the selected destination (destinations) from the transmission destination list 61 or move the selected destination (destinations) to the telephone directory destination list 62.

The UI image 60 can include a return button 65, a next button 66, a cancel button 67, and a help button 68. The return button 65, the next button 66, and the cancel button 67 are respectively buttons having the same functions as the functions of the return button 53, the next button 54, and the cancel button 55. Only a target of a UI Image is different. The help button 68 is a button having the same function as the function of the help button 56. When the help button 68 is selected, information serving as support for setting in the UI image 60 is displayed.

Subsequently, in a state in which the UI image 60 is displayed by the processing in step S15, the user U inputs one or a plurality of destinations serving as FAX transmission destinations from the operation unit 14, and selects the next button 66. As explained above, the user U inputs the FAX number to the general-purpose printer driver 16 (step S16). One or a plurality of destinations can be input as explained below. That is, the user U selects a destination to be set as a FAX transmission destination out of the telephone directory destination list 62 and selects the add button 63, whereby the destination is added to the transmission destination list 61 and the user can input the destination. For a destination added to the transmission destination list 61 by mistake, the user U selects the destination and selects the delete button 64 to thereby be able to exclude the destination from FAX transmission destinations.

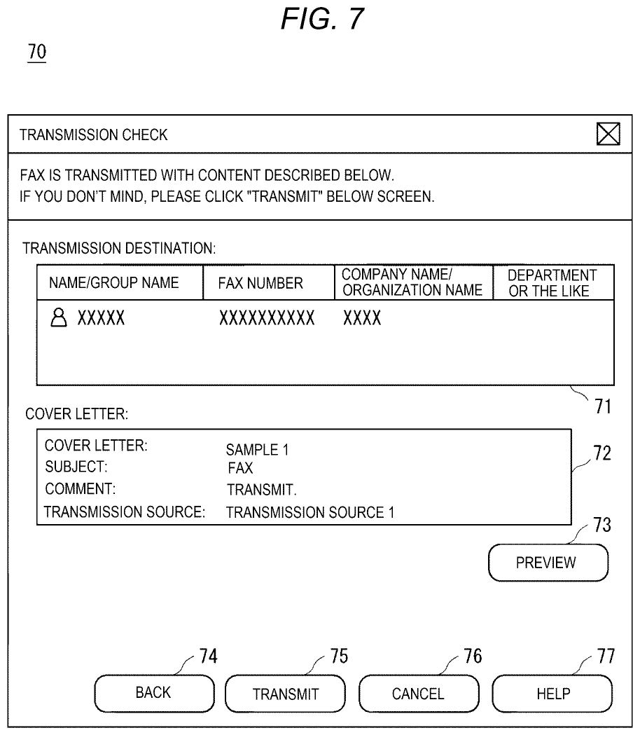

Subsequently, when the input in step S16 is completed by the selection of the next button 66, for example, the general-purpose printer driver 16 displays a confirmation UI image such as a UI image 70 illustrated in FIG. 7. The general-purpose printer driver 16 can also display the confirmation UI image via the vendor auxiliary App 17.

The UI image 70 can include a transmission destination list 71, cover letter information 72, a preview button 73, a return button 74, a transmission button 75, a cancel button 76, and a help button 77. The transmission destination list 71 displays information indicating one or a plurality of destinations set as FAX transmission destinations. The cover letter information 72 displays information indicating an overview of a cover letter transmitted to a FAX transmission destination. The preview button 73 is a button for displaying, as a preview, content of FAX to be transmitted and can display a UI image including the preview by being selected by the user U. The return button 74 is a button for returning to the previous UI image. The transmission button 75 is a button for performing instruction to start transmission of set FAX. The cancel button 76 is a button having the same function as the function of the cancel button 45. A target of a UI image is only different. The help button 77 is a button having the same function as the function of the help button 46. When the help button 77 is selected, information serving as support for operation in the UI image 70 is displayed.

When the user U determines that there is no problem as a result of checking the kinds of setting in a state in which the UI image 70 is displayed, the user U selects the transmission button 75 to notify a printing start to the general-purpose printer driver 16 (step S17). When the user U determines that there is a problem in any of the kinds of setting, the user U only has to select the return button 74.

The general-purpose printer driver 16 having received the notification of the printing start in step S17 notifies the printing start and notifies all destinations set by the user U to the vendor auxiliary App 17 (step S18).

Subsequently, the vendor auxiliary App 17 reads the destinations notified by the notification in step S18 and repeats generation of a print job and notification to the general-purpose printer driver 16 by the number of the read destinations (step S19). In step S19, for the destinations, the vendor auxiliary App 17 notifies, to the general-purpose printer driver 16, printing of a FAX transmission target file in print setting to which the print setting input in step S7 by the user U and information indicating the read FAX number are given. Here, the given print setting can be included in the print job together with the print data indicating the FAX transmission target file as print control data. For example, the print control data can be data of IPP Attribute.

In response to the notification in step S19, the general-purpose printer driver 16 instructs printing by transmitting print jobs to the printer A(31) (step S20). The printer A(31) receives the print jobs and transmits print data by FAX to a FAX transmission destination that is one or a plurality of destinations indicated by the print jobs. For example, when destinations indicated by the FAX transmission destination is the facsimile A(21) and the facsimile B(22), the facsimile A(21) and the facsimile B(22) store the received print data. Alternatively, the facsimile A(21) and the facsimile B(22) perform printing based on the received print data to produce a print. The example is explained in which the destination indicated by the FAX transmission destination is the FAX number. However, the destination may be, for example, an e-mail address of facsimile.

The example is explained in which the instruction for printing via the general-purpose printer driver 16 is explained in steps S19 and S20. However, for example, the vendor auxiliary App 17 may directly instruct the printer A(31) to perform printing. In that case, communication between the vendor auxiliary App 17 and the printer A(31) is desirably executed according to a protocol obtained by vendor extension of IPP or another SNMP or a protocol unique to the vendor. SNMP is an abbreviation for Simple Network Management Protocol.

As exemplified in steps S8 to S16, the printing control program incorporated into the vendor auxiliary App 17 can include a program for causing a computer such as the terminal device 10 to execute destination specifying processing explained below. The destination specifying processing is processing of receiving call operation for a telephone directory from the user U via the setting UI image, displaying the telephone directory on the setting UI image according to the call operation, and causing the user U to specify a destination of FAX. The destination specifying processing is processing of designating a destination. Therefore, the destination specifying processing can also be referred to as destination designation processing.

As exemplified as the data of the IPP Attribute in step S19, the print control data can include data indicating attribute information indicating attributes of a printer set by the general-purpose printer driver 16. The attribute information can be information indicating capability and a state of the printer A(31). For example, when the general-purpose printer driver 16 is an IPP Class driver, the attribute information can be IPP Attribute explained below. That is, in this case, the IPP attribute can indicate any one of, for example, Printer Attribute, Enable Printer, Printer Description Attribute, and the like set as setting values of IPP.

As exemplified in the notification processing in step S19, when one print data is received from the general-purpose printer driver 16 and N destinations are acquired as FAX transmission destinations, the instruction processing in the printing control program can be processing of performing processing explained below. That is, in this case, the instruction processing is processing of generating N print jobs respectively corresponding to the N destinations and transmitting the generated N print jobs to the general-purpose printer driver 16. N is an integer equal to or larger than 1.

In a first example of the FAX transmission processing, effects explained below are achieved in the terminal device 10 in which the general-purpose printer driver 16 of the OS standard is incorporated. That is, when FAX transmission is performed, at the time of transmission of print jobs that are FAX transmission jobs, the terminal device 10 can transmit the print jobs to respective destinations at a time according to a destination of the telephone directory stored in the terminal device 10. Transmitting a plurality of print jobs at a time as explained above cannot be implemented in the comparative example explained above.

However, the example is explained in which one or a plurality of destinations can be optionally designated in step S16. However, only one destination may be able to be designated. In this case, the acquisition processing in the printing control program is processing of acquiring only one destination at a time as a FAX transmission destination. In this case, N described above in the instruction processing corresponds to 1.

Concerning steps S3 to S6, the general-purpose printer driver 16 may adopt a configuration adapted to FAX transmission as well according to a setting value of any IPP such as Enable-Printer or Printer Attribute in IPP printing. Accordingly, the general-purpose printer driver 16 can automatically switch, based on the setting value, whether to display or hide the FAX transmission destination in the basic print setting image such as the UI image 40. For example, the general-purpose printer driver 16 can automatically switch, based on the setting value, whether to display the applied setting button 42 in the UI image 40.

The check of the telephone directory by the vendor auxiliary App 17 explained in steps S10 to S13 may be executed not when the telephone directory is designated as illustrated in FIG. 2 but when the print start instruction is received in step S17. In this case, notification of deficiency to the user U is omitted. Accordingly, although FAX is not transmitted to a destination having deficiency, the user can omit time and effort for inputting a telephone directory again.

Concerning step S20, the vendor auxiliary App 17 may have a function of displaying a print status for each of transmitted print jobs. Alternatively, the general-purpose printer driver 16 may have a function of displaying a print status for each of transmitted print jobs via the vendor auxiliary App 17. In both of the configurations, a print status such as an error or a success for the print jobs can be presented to the user U.

The general-purpose printer driver 16 can also perform processing explained below when attribute information such as an explanatory value of a printer such as Printer Description Attribute supported by IPP printing is not adapted to color. In this case, in step S20, the general-purpose printer driver 16 converts print data to be automatically transmitted into monochrome data and transmits the monochrome data. Accordingly, even if the user U does not optionally set monochrome printing, the user U can automatically switch a printer not adapted to color to the monochrome printing.

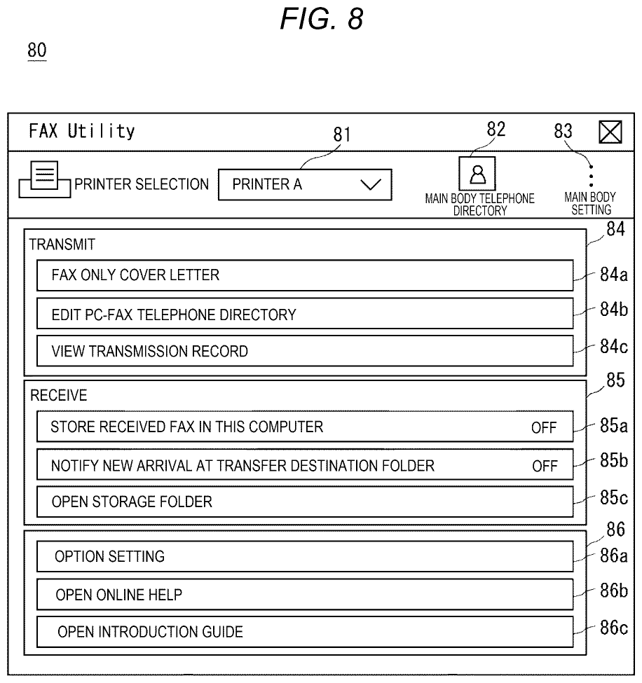

The vendor auxiliary App 17 or another application program can add a function of displaying a pre-registered PC-FAX telephone directory like Windows FAX utility. For example, an instruction to display a setting image of the FAX Utility exemplified by a UI image 80 in FIG. 8 by the user U is given to the vendor auxiliary App 17 or another application program via the general-purpose printer driver 16. The vendor auxiliary App 17 or another application program having received the instruction can display the setting image of the Fax Utility exemplified by the UI image 80.

The UI image 80 may include a printer selection menu 81, a main body telephone directory display button 82, and a main body setting button 83. In the printer selection menu 81, a state in which the printer A(31) is currently selected is illustrated. However, user operation for changing the printer A(31) to the printer B(32) or the printer C(33) can be received. The main body telephone directory display button 82 can be a button for displaying a UI image that can be edited by opening the PC-FAX telephone directory. Alternatively, the main body telephone directory display button 82 can also be a button for opening the PC-FAX telephone directory stored in the main body of the terminal device 10 and displaying a UI image for selecting a FAX transmission destination. This UI image can be exemplified by the UI image 60 in FIG. 6. The main body setting button 83 is a button for displaying a UI image for performing various kinds of setting.

The UI image 80 may include a transmission setting field 84, a reception setting field 85, and an option setting field 86. The transmission setting field 84 can include a button 84a for transmitting only a cover letter by FAX, a button 84b for editing the PC-FAX telephone directory, and a button 84c for viewing a transmission record. The reception setting field 85 can include a button 85a for storing received FAX in the computer, a button 85b for notifying new arrival at a transfer destination folder, and a button 85c for opening a storage folder. The computer explained above indicates the terminal device 10. All of the buttons 84a, 84b, 84c, 85a, 85b, and 85c also display UI images of contents indicated by the buttons. For example, the user U can shift the UI image to the UI image 50 in FIG. 5 by selecting the button 84a.

The option setting field 86 includes an option setting button 86a for shifting to a UI image for performing setting concerning FAX transmission and reception other than the items set in the transmission setting field 84 and the reception setting field 85. The option setting field 86 can include a button 86b for opening online help, a button 86c for opening an introduction guide, and the like.

### Second Example of the FAX Transmission Processing

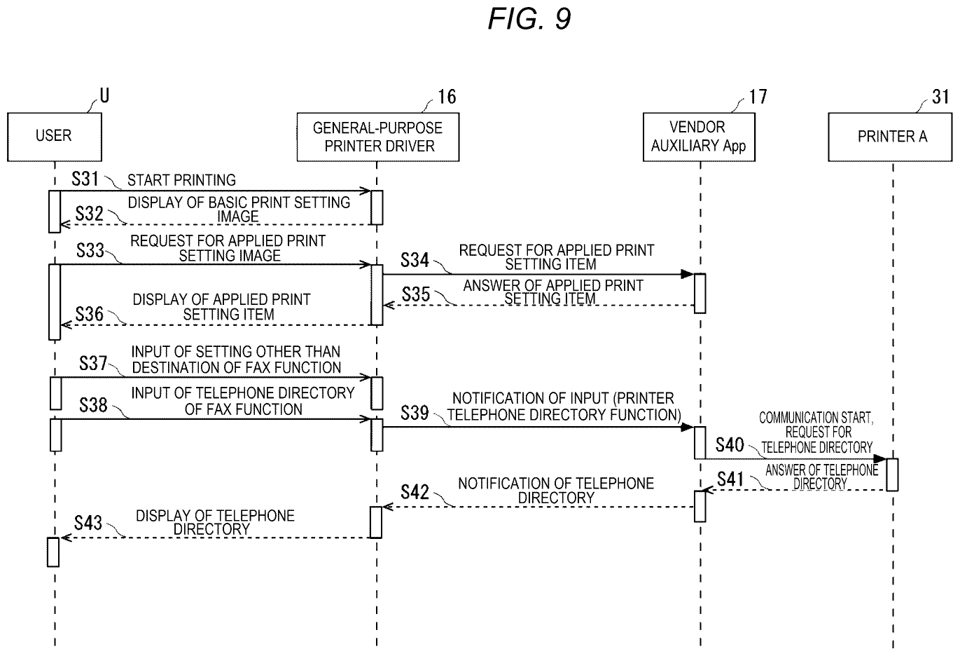

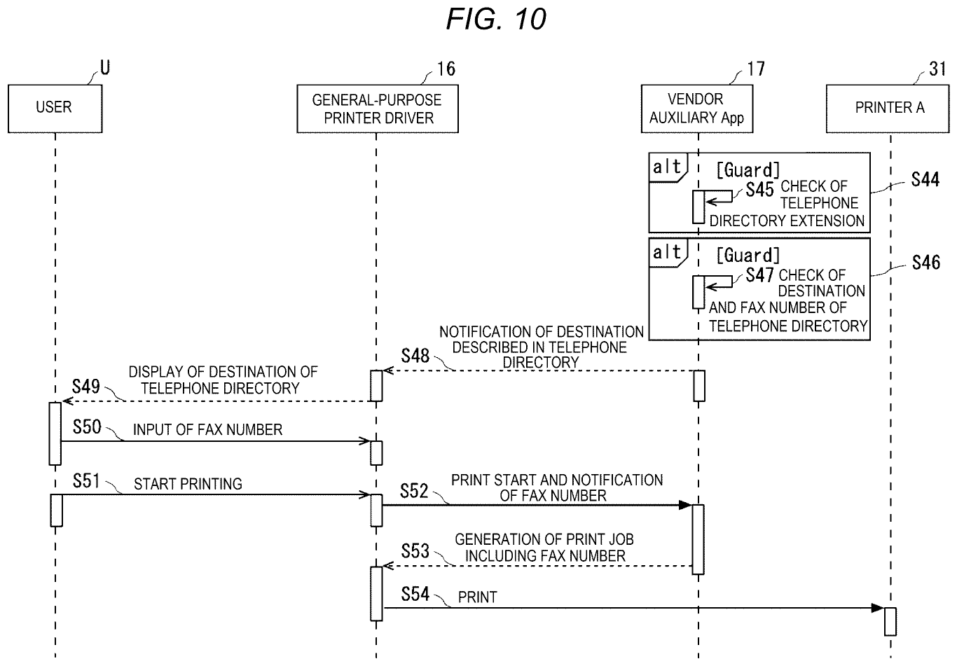

A second example of the printing processing according to the present embodiment is explained with reference to FIGS. 9 and 10. FIG. 9 is a sequence diagram illustrating the second example of the FAX transmission processing in the print system 100 illustrated in FIG. 1. FIG. 10 is a sequence diagram following FIG. 9. In the following explanation, changes from the first example are mainly described as the second example. However, the other points including application of various applied examples of the points are the same.

In the second example, as in the first example, an example is explained in which the vendor auxiliary App 17 is implemented with the printing control program for performing the display processing, the acquisition processing, and the instruction processing explained above. In the second example, as in the first example, an example is explained below in which a FAX transmission request is performed from the terminal device 10 to the printer A(31). However, the same applies when FAX transmission requests to the other printers are performed.

In the second example as well, the FAX transmission processing in the case in which a function of a telephone directory is used for designation of a FAX transmission destination is explained. However, the second example is different from the first example in that a telephone directory registered in a printer main body is used and is the same processing in other points. Thus, in the second example as well, the processing in steps S1 to S9 of the first example are applied (steps S31 to S39). However, in step S38, the user U performs input for designating a telephone directory stored in the printer A(31) as a telephone directory read from the vendor auxiliary App 17. The general-purpose printer driver 16 receives this input. In step S39, the general-purpose printer driver 16 notifies the input to the vendor auxiliary App 17.

In response to this notification, the vendor auxiliary App 17 starts communication with the printer A(31) and requests a telephone directory registered in a main body of the printer A(31) (step S40). As explained above, the communication is desirably executed according to a protocol obtained by vendor extension of the IPP or another SNMP or a protocol unique to the vendor. The printer A(31) having received the request in step S40 transmits the stored telephone directory to perform an answer (step S41). Subsequently, the vendor auxiliary App 17 receives the notification of the telephone directory and returns the notification to the general-purpose printer driver 16 (step S42). The general-purpose printer driver 16 performs an answer to the user U by displaying content indicated by the received telephone directory on the UI image (step S43). Although not illustrated, the UI image displayed here can be, for example, a UI image indicating only a telephone directory destination list such as the telephone directory destination list 62 in the UI image 60 in FIG. 6. However, here, it is indicated that the telephone directory destination list is not a PC-FAX telephone directory but a telephone directory registered in the printer A(31).

Next, the vendor auxiliary App 17 executes the check explained in steps S10 to S13 on the telephone directory answered in step S41 (steps S44 to S47). Subsequently, basically the same processing as the processing in steps S14 to S17 is executed (steps S48 to S51). In step S49, as in step S15, for example, a UI image like the UI image 60 in FIG. 6 is displayed. However, here, it is indicated that the telephone directory destination list is not the PC-FAX telephone directory but is the telephone directory registered in the printer A(31).

The general-purpose printer driver 16 having received the notification of the printing start in step S51 notifies the printing start to the vendor auxiliary App 17 and notifies FAX numbers of all destinations set by the user U to the vendor auxiliary App 17 (step S52).

Subsequently, the vendor auxiliary App 17 reads the Fax numbers notified by the notification in step S52 and repeats the generation of the print job and the notification to the general-purpose printer driver 16 by the number of the read FAX numbers (step S53). In step S53, the same processing as the processing in step S19 can be performed.

In response to the notification in step S53, as in step S20, the general-purpose printer driver 16 instructs printing by transmitting print jobs to the printer A(31) (step S54). The printer A(31) receives the print jobs and transmits print data by FAX to FAX transmission destinations, which are one or a plurality of FAX numbers indicated by the print jobs. For example, when the FAX numbers indicated by the FAX transmission destinations are the facsimile A(21) and the facsimile B(22), the facsimile A(21) and the facsimile B(22) store the received print data. Alternatively, in this case, the facsimile A(21) and the facsimile B(22) perform printing based on the received print data to produce a print. Here, an example is explained in which a destination indicated by a FAX transmission destination is a FAX number. However, the destination may be, for example, an e-mail address of facsimile.

In the second example, unlike the first example, FAX transmission processing can be performed using a telephone directory registered in the printer main body.

In the second example, the telephone directory registered in the printer main body is used. However, the vendor auxiliary App 17 can have a function of storing a telephone directory in the terminal device 10 in synchronization with the telephone directory registered in the printer main body.

### Other Modifications

The present disclosure is not limited to the embodiment explained above and can be changed as appropriate without departing from the gist of the present disclosure. For example, the system configuration of the print system, the configurations of the devices configuring the system, the configurations of the programs included in the devices, the processing procedures of the devices, and the like are not limited to the exemplified ones. The print system can adopt a network configuration in which a terminal device is connected to a printer via a print server. In the embodiment explained above, the FAX communication using the public telephone line is explained. However, FAX communication is not limited to such FAX communication. That is, the present disclosure may be applied to a case in which FAX communication based on standards such as T.30, T.37, T.38, and T.62 of ITU-T is performed. ITU-T is an abbreviation for International Telecommunication Union Telecommunication Standardization Sector.

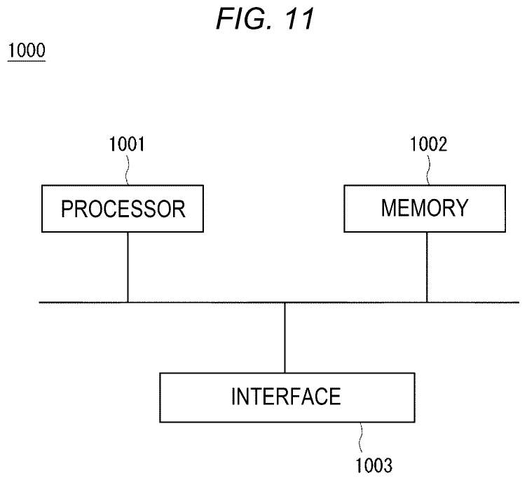

All of the devices provided in the print system according to the embodiment explained above can include, for example, hardware components explained below. Examples of the devices include a terminal device, printers, and facsimile machines in the example illustrated in FIG. 1. FIG. 11 is a diagram illustrating an example of hardware components of a device.

A device 1000 illustrated in FIG. 11 can include a processor 1001, a memory 1002, and an interface 1003. The interface 1003 can include, for example, a communication interface and an interface with an input and output device that are required according to the device.

The processor 1001 may be, for example, a CPU, a GPU, or a microprocessor unit (MPU) also referred to as microprocessor. The processor 1001 may include a plurality of processors. The memory 1002 is configured by, for example, a combination of a volatile memory and a nonvolatile memory. Functions in the devices are implemented by the processor 1001 reading a program stored in the memory 1002 and executing the program while exchanging necessary information via the interface 1003.

The program includes an instruction group (or software codes) for causing a computer to perform the one or more functions explained in the embodiment when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or another memory technology. Not as a limitation but as an example, the computer-readable medium or the tangible storage medium includes a CD-ROM, a digital versatile disc (DVD), a Blu-ray (registered trademark) disk, or another optical disc storage or a magnetic cassette, a magnetic tape, a magnetic disk storage, or another magnetic storage device. The program may be transmitted on a transitory computer-readable medium or a communication medium. Not as a limitation but as an example, the transitory computer-readable medium or the communication medium includes a propagation signal of an electric, optical, acoustic, or another form.

The present disclosure is explained above with reference to the embodiment. However, the present disclosure is not limited to only the configuration in the embodiment explained above. It goes without saying that the present disclosure includes various modifications, alterations, and combinations that can be made by those skilled in the art within the scope of the disclosure of the claims of the present application.

What is claimed is:

1. A non-transitory computer readable storage medium storing a printing control program, the printing control program causing a computer to execute:
display processing of displaying a setting image in response to a request from a general-purpose printer driver;
acquisition processing of acquiring, via the setting image, a FAX transmission destination to be a destination of FAX; and
instruction processing of passing print control data including the FAX transmission destination to the general-purpose printer driver and causing the general-purpose printer driver to execute a print instruction conforming to the print control data and serving as a FAX transmission instruction to a printer having a FAX transmission function.

2. The non-transitory computer-readable storage medium storing the printing control program according to claim 1, wherein the printing control program is a Print Support Application.

3. The non-transitory computer-readable storage medium storing the printing control program according to claim 1, the printing control program further causing the computer to execute destination specifying processing of receiving call operation for a telephone directory from a user via the setting image, displaying the telephone directory on the setting image in response to the calling operation, and causes the user to specify the destination.

4. The non-transitory computer-readable storage medium storing the printing control program according to claim wherein the print control data includes data indicating attribute information indicating an attribute of the printer set by the general-purpose printer driver.

5. The non-transitory computer-readable storage medium storing the printing control program according to claim 1, wherein the instruction processing is processing of receiving one print data from the general-purpose printer driver and, when destinations of N parts are acquired as the FAX transmission destination, generating N print jobs respectively corresponding to the destinations of the N parts and transmitting the generated N print jobs to the general-purpose printer driver.

6. The non-transitory computer-readable storage medium storing the printing control program according to claim 1, wherein the acquisition processing is processing of acquiring only one destination at a time as the FAX transmission destination.

7. A FAX control device comprising:
a general-purpose printer driver;
a display processing unit configured to display a setting image in response to a request from the general-purpose printer driver;
an acquisition processing unit configured to acquire, via the setting image, a FAX transmission destination to be a destination of a FAX; and
an instruction processing unit configured to pass print control data including the FAX transmission destination to the general-purpose printer driver and cause the general-purpose printer driver to execute a print instruction conforming to the print control data and serving as a FAX transmission instruction to a printer having a FAX transmission function.

8. A FAX control method comprising:
display processing of displaying a setting image in response to a request from a general-purpose printer driver;
acquisition processing of acquiring, via the setting image, a FAX transmission destination to be a destination of FAX; and
instruction processing of passing print control data including the FAX transmission destination to the general-purpose printer driver and causing the general-purpose printer driver to execute a print instruction conforming to the print control data and serving as a FAX transmission instruction to a printer having a FAX transmission function.
